(19) United States
(12) Patent Application Publication
(10) Pub. No.: US 2024/0172338 A1
(43) Pub. Date: May 23, 2024

(54) Device and Process for Transforming a Material

(71) Applicant: Ultra High Temperature Processes Ltd, Dublin (IE)

(72) Inventor: Nils Kongmark, Saint-Genis-Pouilly (FR)

(21) Appl. No.: 18/283,289

(22) PCT Filed: Mar. 15, 2022
(86) PCT No.: PCT/EP2022/056759

§ 371 Date: Sep. 21, 2023

(30) Foreign Application Priority Data
Mar. 22, 2021 (EP) 21315049.3

(51) Int. Cl. H05B 6/70

(52) U.S. Cl. CPC H05B 6/707

(57) ABSTRACT

The invention relates to a device for transforming a material, comprising means for exposing the material to a high-powered electromagnetic field in order to perform a volumetric heating of the material. The particularity of such a device is that the above means comprise at least two torus-shaped waveguides (1,2,5) vertically disposed on one another, each torus-shape waveguide being associated on one side with a magnetron (3) and having on another side a vertically extending hole, the holes being aligned and forming a general vertical hole (4) for receiving the material to be transformed. The invention also pertains to a process for transforming a material and to uses of the transformed material.

The invention relates to a device for transforming a material by exposing it to a high-powered electromagnetic field to perform its volumetric heating.

The invention also pertains to a process for transforming a material and to uses of the transformed material.

### BACKGROUND OF THE INVENTION

European patent application published under No. EP 3 293 478 discloses a counter-flow ceramic heat exchanger assembly and a method for making the same. The cited ceramics are aluminum nitride, alumina and silicon nitride which are known to withstand temperatures of at least 800° C.

International patent application published under No. WO 2014206905 relates to a volumetric heating device for beverages in a food preparation machine, comprising
an emission source designed for emitting electromagnetic radiation and to transfer the energy to a liquid at least partially surrounding the emission source,
a liquid conduct, and
an isolation means essentially transparent to the electromagnetic radiation in the emitted spectrum and designed to electrically isolate the emission source from the liquid.

### SUMMARY OF THE INVENTION

The main goal of the invention is to provide materials that can withstand ultra-high temperatures or that have been submitted to a ultra-high temperature.

To reach that goal, the inventor has conceived a device for treating or transforming a material, which comprises means for exposing the material to a high-powered electromagnetic field to perform a volumetric heating of the material. The particularity of that device is that said means comprise at least two torus-shaped waveguides vertically disposed on one another, each torus-shape waveguide being associated on one side with a magnetron and having on another side a vertically extending hole, the holes being aligned and forming a general vertical hole for receiving the material to be transformed.

In accordance with another aspect, the invention relates to a process for transforming a material, comprising the steps of:
introducing the material to be transformed into the general vertical hole of the above device and
activating the magnetrons in order to expose the material to a high-powered electromagnetic field and perform its volumetric heating.

Other aspects of the invention concern the uses of the process of the invention and uses of the material transformed according to the invention.

Other features and advantages of the invention will now be described in detail in the following description, which refers to the appended figures that schematically show:

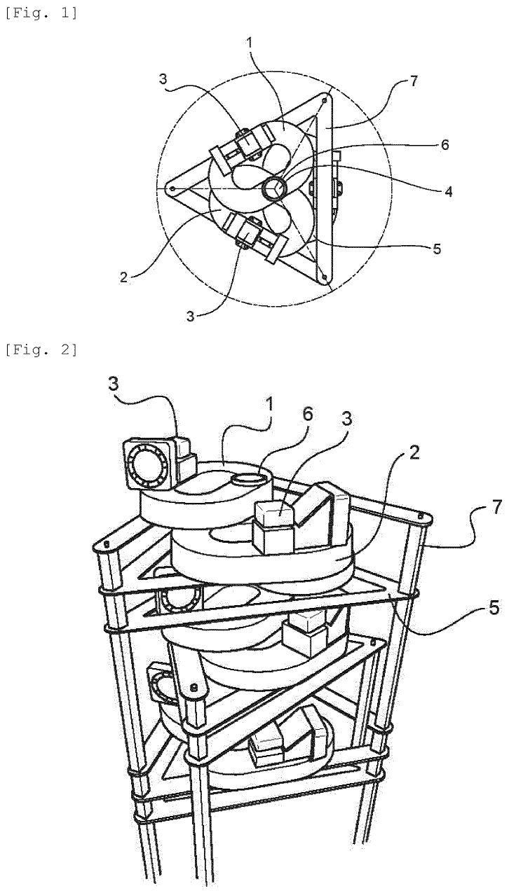

FIG. 1: a top view of a device according to an embodiment of the invention; and

FIG. 2: a side view of the device of FIG. 1.

### DETAILED DESCRIPTION OF THE INVENTION

Device for Transforming a Material

By volumetric heating, it must be understood that the material undergoes an intrinsic heating. This is obtained when electrical charges within the material react due to the exposition to electromagnetic fields—for dielectric materials, through dipolar polarization and ionic conduction. With a dielectric heating, electric energy is converted into kinetic energy, ultimately converted into heat. In other words, the heat is created by the material itself, which depends on its mechanical, thermal and dielectric properties as well as the electromagnetic field.

The device and process of the invention provide an exceptionally good heating homogeneity with temperature variations between any two points limited to about 2° C.

An embodiment of the device of the invention is shown in FIGS. 1 and 2. It comprises at least two torus-shaped waveguides 1,2 vertically disposed on one another. Each torus-shape waveguide is associated with a magnetron 3 on one side and has a hole vertically extending through the other side. Inside the holes, tubes 6 are inserted. The tubes 6 may be made of metal. In that case they are preferably insulated where necessary in order to avoid any electrical contact with the support structure 7 which is generally made of metal.

The holes of the waveguides are aligned and they form a general vertical hole 4 with their tubes 6 also aligned and designed to receive the material to be transformed.

For processing temperatures over 1500° C., the tubes 6 are preferably made of a ceramic material adapted to the temperatures. The means for holding the tubes 6 should also be able to withstand temperatures higher by at least 200° C. than the processing temperatures, in other to keep its shape. Besides, the holding means must be essentially transparent to electromagnetic waves.

As shown on FIG. 1, the device of the invention preferably comprises at least three torus-shaped waveguides 1,2,5 offset by an angle of 120 degrees to each other.

The holes and the respective magnetrons 3 are preferably symmetrically arranged, on opposed positions of the waveguides.

The torus-shaped waveguides may not be strictly torus-shaped: they may have an elongated torus-shaped form like in the appended figures, each magnetron and each respective hole preferably being at a respective oblong part of the elongated waveguide, preferably in the middle of it.

Means for vertically moving the material in the general vertical hole 4, preferably from bottom to top, are preferably provided.

Means for rotating the material may also be provided when the material is solid, in particular in powder form.

Liquid material need not to be stirred because their flow is either turbulent of laminated, but mostly turbulent due to the use of pumps.

Preferably, means are also provided to make an inert gas like nitrogen flow through the general vertical hole 4, preferably from bottom to top.

With the device of the invention, many kinds of transformations or treatments of the material can be contemplated.

For example, the transformation may consist in a ultra-high temperature (UHT) sterilization of a liquid like milk. The UHT for milk sterilization preferably is 138 to 142° C.

The transformation may also be the melting of a powder material, the sintering of a material, an atomic transformation like a change of crystal structure, or a change of a molecular structure, like a rearrangement. In that case, UHT means a temperature preferably over 2000° C. and more preferably above 3000° C.

In a preferred embodiment, the transformation is a UHT transformation of a solid material like a ceramic material, preferably in powder form.

The device may then preferably comprise:
means for measuring the dielectric evolution of the material during its temperature ramping caused by the volumetric heating and
electronic control means for adapting the exposure of the material to the measured dielectric values as well as to the nature of the material.

The means for measuring the material dielectric evolution may be sensors, preferably vertically arranged, respectively at each waveguide.

The electronic control means generally comprise a computer with an appropriate computer program which continuously calculates and adapts the quantity of energy to be supplied by each magnetron, on the basis of the respective measured dielectric constant and the kind of material under transformation.

The waveguides direct the electromagnetic waves produced by the magnetrons to the respective holes of the waveguides. By use of a mono-mode and combinations of H-bends and E-bends of the electromagnetic waves, the exposure is guaranteed to be perfectly homogeneous.

When the material is within the general vertical hole 6, it absorbs energy due its dielectric properties and transforms it into heat energy. The dielectric properties here are both the dielectric constant and the loss factor (i.e. the part of the absorbed energy that is transformed in to heat).

For example, with a ceramic material, temperatures up to 2200° C. and above can be reached.

The vertical movements may be up-and-down movements, for example 30 times/min and/or the rotation speed is for example 30 revolutions/min. This improves the homogeneity of the exposure.

The magnetrons are usually cooled by water or another liquid or gaseous refrigerant.

It is specified that the exposure performs a heating is commonly called ‘volumetric’, that means that the whole material mass is instantly submitted to a temperature increase, which is related and adapted to both the power injection from the magnetrons and the dielectric properties in the material which change with the temperature variations. The computer program rules the variations in relation with the sensors throughout the general vertical hole 6 which measure the dielectric properties, i.e., the dielectric constant and the loss factor of the material. The dielectric properties (dielectric constant and loss factor) are preferably determined with a spectrograph or a network analyzer transformed and fed to the computer program.

In this way, it is possible to make quick and accurate adjustments, which, particularly in the case of a ceramic, reduces the risks of cracking and fissuring.

Process for Transforming a Material

The device of the invention may advantageously be used to carry out a process for transforming a material, comprising the steps of:
introducing the material into the general vertical hole of the device and
activating the magnetrons in order to expose the material to a high-powered electromagnetic field and perform its volumetric heating.

Such a process preferably further comprises the step of moving the material in the general vertical hole 4, preferably from bottom to top.

It also preferably comprises the step of rotating the material, when the material is solid.

The duration of the exposure of the material to the high-powered electromagnetic field preferably depends on the characteristic and mass of the material.

According to a preferred embodiment, the process of the invention further comprises the steps of
measuring the material dielectric evolution of the material during its temperature ramping and
adapting the exposure of the material to the measured dielectric values as well as to the nature of the material.

The materials treated or transformed by the process of the invention were analyzed and appeared to be not only treated/transformed but also new. In addition, they have better properties than before the treatment/transformation according to the invention.

Uses of the Process of the Invention

As explained above, the process of the invention may advantageously be used to transform milk into a ultra-high temperature sterilized milk.

In an experimental pilot, milk was transformed with the device of FIGS. 1 and 2. The magnetrons were cooled with air. The flow of milk was 250 l/h and a 12 kW overall power supplied to the magnetrons. A temperature of 142° C. was applied to the milk, which gave a heat recovery of 117° C. in the milk. In other words, the set temperature 142° C. was reached but not exceeded so the Maillard reaction could be activated, which happens at 156° C. The delta T was thus only 25° C. (i.e. 142−117).

To draw a comparison, in a conventional UHT milk sterilization method, the temperature is usually made to rise up to 200° C. to ensure that a temperature of 142° C. is achieved. However, such a high temperature has the disadvantage of destroying many proteins in the milk.

By contrast, the process of the invention makes it possible to keep the processing temperature at 142° C.

In the milk transformed according to the invention, no bacteria were detected and 34% more soluble proteins were detected in comparison with a conventional UHT milk. In addition, no deposit/fouling was observed in the process tube, which confirms that no significant destruction of proteins took place.

The process of the invention may also be used to transform a ceramic material into a ultra-high temperature ceramic (UHTC).

In an experiment, temperature of 2400° C. was obtained and used to treat y-alumina with the process of the invention. A new form of alumina was obtained, which could withstand temperatures of 2400° C. when used as glass cover of halogen lamps placed in normal air at room temperature.

Process for Reducing the Emission of Greenhouse Gases

Since a ceramic transformed according to the invention resists higher temperature, by using it in a burner, it becomes possible to increase the working temperature of that burner.

An increase of the working temperature of the burner is obtained when the latter is supplied with pure oxygen instead of air.

And when pure oxygen is used, the formation of unburnt gases and carbon dioxide decreases of up to 75%.

The overall result is a reduction of the emission of greenhouse gases.

In addition, the size of the equipment can be reduced, because for the same volume of pure oxygen, 5 times more air is normally necessary.

Process for Increasing the Travelling Speed of a Missile, Rocket or Aircraft

Since a ceramic transformed according to the invention resists higher temperatures, by using it in the nose of a missile, in the tip of a rocket or in the wing front edges of an aircraft, it becomes possible to increase the travelling speed of that missile, rocket or aircraft.

Process for Improving the Lift Power or for Resisting the Friction with the Atmosphere of a Missile, Rocket or Aircraft

Since a ceramic transformed according to the invention resists more elevated temperatures, it can resist higher gas (air) friction and therefore higher gas velocities, which means that the lift power of a missile, rocket or aircraft can be augmented.

The transformed material can then advantageously be placed in the nose of a missile, in the tip of a rocket tip or in the front edges of the wings of an aircraft.

Heat Exchanger According to the Invention

A ceramic material as transformed by the process of the invention may advantageously be used in a heat exchanger, making it possible to produce a heat exchanger able to work at ultra-high temperatures like 2250° C. and in a corrosive medium, liquid or gaseous like an atmosphere of oxygen or steam.

Such an exchanger can then advantageously be used in an apparatus for splitting water into hydrogen and oxygen by thermolysis of water like that disclosed in the above U.S. Pat. No. 7,935,254. The transformed ceramic material is most preferably used in the device and process described in European patent application filed by the Applicant on 4 Feb. 2021 under filing number EP21315016.2

In particular, a transformed ceramic material obtained from a mixed ionic-electronic conducting (MIEC) ceramic material may advantageously be used as a filter for oxygen or hydrogen.

Heating Unit

A ceramic material as transformed by the process of the invention may advantageously be used in a heating unit, for example like the heating unit described in European patent application filed by the Applicant on 5 Feb. 2021 under filing number EP21315017.0

1. A device for transforming a material, comprising means for exposing the material to a high-powered electromagnetic field in order to perform a volumetric heating of the material characterized in that
said means comprise at least two torus-shaped waveguides (1,2,5) vertically disposed on one another,
each torus-shape waveguide being associated on one side with a magnetron (3) and having on another side a vertically extending hole,
the holes being aligned and forming a general vertical hole (4) for receiving the material to be transformed.

2. The device of claim 1 having at least three torus-shaped waveguides (1,2,5) offset by an angle of 120 degrees to each other.

3. The device of claim 1 or 2, further comprising means for rotating or stirring the material and/or means for vertically moving the material in the general vertical hole (4).

4. The device of any one of claims 1 to 3, further comprising:
means for measuring the material dielectric evolution of the material during its temperature ramping and
electronic control means for adapting the exposure of the material to the measured dielectric values as well as to the nature of the material.

5. A process for transforming a material, comprising the steps of:
introducing the material to be transformed into the general vertical hole (4) of a device according to any one of claims 1 to 4 and
activating the magnetrons (3) in order to expose the material to a high-powered electromagnetic field and perform its volumetric heating.

6. The process of claim 5, further comprising the step of rotating and/or vertically moving the material in the general vertical hole (4).

7. The process of claim 5 or 6, wherein it is applied to the material for a duration which depends on the characteristic and mass of the material submitted to the exposure.

8. The process of any one of claims 5 to 7, further comprising the steps of
measuring the material dielectric evolution of the material during its temperature ramping and
adapting the exposure of the material to the measured dielectric values as well as to the nature of the material.

9. Use of the process of any one of claims 5 to 8 to transform a ceramic material into a ultra-high temperature ceramic (UHTC), the UHT being at least 2000° C.

10. Use of the process of claim 5 or 6 to transform milk into a ultra-high temperature (UHT) sterilized milk, the UHT being 138-142° C.
